(19) United States
(12) Patent Application Publication
(10) Pub. No.: US 2023/0387954 A1
(43) Pub. Date: Nov. 30, 2023

(54) SELECTIVE ANTENNA TERMINATION

(71) Applicant: QUALCOMM Incorporated, San Diego, CA (US)

(72) Inventors: Erwin SPITS, Utrecht (NL); Adrianus VAN BEZOOIJEN, Molenhoek (NL); Francesco GATTA, San Diego, CA (US); Ryan Scott Castro SPRING, San Diego, CA (US)

(21) Appl. No.: 18/315,336

(22) Filed: May 10, 2023

Related U.S. Application Data
(60) Provisional application No. 63/345,243, filed on May 24, 2022.

(51) Int. Cl. H04B 1/16; H04B 1/00

(52) U.S. Cl. CPC H04B 1/1615; H04B 1/006

(57) ABSTRACT

An antenna detuning method includes: time domain duplexing signal transmission and signal reception by a first antenna of a wireless communication device; providing one or more first indications of time domain duplexing and one or more second indications of signal transmission to a semi-autonomous hardware controller of the wireless communication device; and responding, at the semi-autonomous hardware controller of the wireless communication device, to the one or more first indications of time domain duplexing and the one or more second indications of signal transmission by coupling a second antenna of the wireless communication device to receive circuitry during signal reception by the first antenna and to a termination during signal transmission by the first antenna.

### CROSS-REFERENCE TO RELATED APPLICATIONS

This application claims the benefit of U.S. Provisional Application No. 63/345,243, filed May 24, 2022, entitled “SELECTIVE ANTENNA TERMINATION,” which is assigned to the assignee hereof, and the entire contents of which are hereby incorporated herein by reference for all purposes.

### BACKGROUND

Wireless communication devices are increasingly popular and increasingly complex. For example, mobile telecommunication devices have progressed from simple phones, to smart phones with multiple communication capabilities (e.g., multiple cellular communication protocols, Wi-Fi, BLUETOOTH® and other short-range communication protocols), supercomputing processors, cameras, etc. Wireless communication devices have antennas to support various functionality such as communication over a range of frequencies, reception of Global Navigation Satellite System (GNSS) signals, also called Satellite Positioning Signals (SPS signals), etc.

With several antennas disposed in a single wireless communication device, coupling between antennas may degrade performance. For example, power in a transmitted communication signal may be received and dissipated by another antenna in the device, e.g., an antenna for receiving GNSS signals, an antenna for receiving and transmitting other communication signals, etc.

### SUMMARY

An example antenna connection/termination device includes: a first antenna port configured to communicatively couple to a first antenna; a first switch communicatively coupled to the first antenna port; transceiver circuitry communicatively coupled to the first switch and including transmit circuitry and first receive circuitry, where the first switch is configured to selectively communicatively couple the first antenna port to the transmit circuitry or the first receive circuitry; a second antenna port configured to communicatively couple to a second antenna; a second switch communicatively coupled to the second antenna port; second receive circuitry communicatively coupled to the second switch; one or more terminations, having a corresponding one or more different impedances, where the second switch is configured to selectively communicatively couple the second antenna port to the second receive circuitry or one of the one or more terminations; a processor communicatively coupled to the transceiver circuitry, the second receive circuitry, the first switch, and the second switch, and configured to provide one or more indications of transceiver operation including time-division multiplexing between operation of the transmit circuitry to transmit a transmit signal and operation of the first receive circuitry, and corresponding selective communicative coupling by the first switch of the first antenna port to the transmit circuitry or to the first receive circuitry; and a hardware switch controller communicatively coupled to the processor and the second switch and configured to control the second switch to communicatively couple the second antenna port to a selected one of the one or more terminations based on the one or more indications of transceiver operation in accordance with the time-division multiplexing between operation of the transmit circuitry and operation of the first receive circuitry.

An example antenna detuning method includes: time domain duplexing signal transmission and signal reception by a first antenna of a wireless communication device; providing one or more first indications of time domain duplexing and one or more second indications of signal transmission to a semi-autonomous hardware controller of the wireless communication device; and responding, at the semi-autonomous hardware controller of the wireless communication device, to the one or more first indications of time domain duplexing and the one or more second indications of signal transmission by coupling a second antenna of the wireless communication device to receive circuitry during signal reception by the first antenna and to a termination during signal transmission by the first antenna.

An example wireless communication device includes: means for time domain duplexing signal transmission and signal reception by a first antenna of the wireless communication device; means for providing one or more first indications of time domain duplexing and one or more second indications of signal transmission to a semi-autonomous hardware controller of the wireless communication device; and means for coupling, in response to the one or more first indications of time domain duplexing and the one or more second indications of signal transmission, a second antenna of the wireless communication device to receive circuitry during signal reception by the first antenna and to a termination during signal transmission by the first antenna.

An example antenna switch apparatus includes: a switch controller; at least one termination impedance; and a switch communicatively coupled to the switch controller, the switch including an antenna port configured to be communicatively coupled to an antenna, a receive port configured to be communicatively coupled to receive circuitry, and at least one termination port each communicatively coupled to a respective one of the at least one termination impedance; where the switch controller is configured to respond to reception of a receive circuitry disable signal by causing the switch to decouple the antenna port of the switch from the receive port of the switch or to couple the antenna port to a selected one of the at least one termination impedance.

Another example wireless communication device includes: transmit circuitry configured to transmit an outbound signal for transmission by a first antenna of a plurality of antennas of the wireless communication device; receive circuitry configured to receive an inbound signal from a second antenna of the plurality of antennas of the wireless communication device, the second antenna being distinct from the first antenna; a processor communicatively coupled to the transmit circuitry and the receive circuitry and configured to transmit a first subset of possible transmission parameter values for the wireless communication device and a second subset of possible transmission parameter values for the wireless communication device; and an antenna switch or an antenna switch module communicatively coupled to the transmit circuitry, the receive circuitry, and the processor, the antenna switch or antenna switch module being configured to receive the first subset of possible transmission parameter values and selectively detune, during a call, the second antenna based on the first subset of possible transmission parameter values, and to receive the second subset of possible transmission parameter values and selectively re-detune the second antenna based on the second subset of possible transmission parameters.

Another example antenna detuning method includes: selectively switching an antenna between connecting to receive circuitry or one of several impedance terminations based on whether another antenna is being used for transmission or reception. The switching may be controlled by a hardware controller that does not receive explicit instructions to switch, but rather semi-autonomously switches based on control (e.g., disable) signals provided to circuitry related to the other antenna.

### BRIEF DESCRIPTION OF THE DRAWINGS

FIG. 1 is a schematic diagram of a communication system.

FIG. 2 is an exploded perspective view of simplified components of a mobile device shown in FIG. 1.

FIG. 3 is a top view of a printed circuit board layer, shown in FIG. 2, including antenna systems.

FIG. 4 is a simplified block diagram of a wireless communication device including an antenna connection/termination device for selectively detuning an antenna.

FIG. 5 is an example of a wireless communication device shown in FIG. 4 configured to selectively detune multiple antennas.

FIG. 6 is a timing chart of use of antennas for transmission, reception, and detuning.

FIG. 7 is a timing diagram of time division duplexing of one antenna and selective detuning of another antenna of the device shown in FIG. 5.

FIG. 8 is a simplified block diagram of elements of a wireless communication device for selective antenna detuning.

FIG. 9 is a simplified diagram of a switch and related components for selectively detuning an antenna.

FIG. 10 is a block diagram of a method of semi-autonomous antenna detuning.

FIG. 11 is a block diagram of a method of antenna detuning.

FIG. 12 is a block diagram of an antenna switch apparatus.

FIG. 13 is a block diagram of another antenna switch apparatus.

FIG. 14 is a block diagram of a wireless communication device.

### DETAILED DESCRIPTION

Techniques are discussed herein for inhibiting power dissipation of a signal transmitting from a first antenna of an electronic device by a second antenna of the electronic device. Transmission parameters of a transmit signal, e.g., the first antenna, a frequency, and a timing of the transmit signal may be provided to a detuning controller of the electronic device. The detuning controller may use the transmission parameters and one or more other indications (e.g., a detuning enablement indication and/or a detuning trigger) to selectively detune the second antenna by connecting the second antenna to a termination that will provide an input impedance at the second antenna that will inhibit reception of the transmit signal by the second antenna (and thus inhibit power dissipation by one or more components downstream from the second antenna). Different terminations may be connected to the second antenna based on different transmission parameter values. The second antenna may be connected to receive circuitry, e.g., when the first antenna is not transmitting. The connection of the second antenna to one or more terminations over time may be coordinated with signal transmission by the first antenna such that the termination connections are time aligned with transmission times, e.g., of time division duplexing slots. Other configurations, however, may be used.

Items and/or techniques described herein may provide one or more of the following capabilities, as well as other capabilities not mentioned. Gain and/or TRP (Total Radiated Power) of a first antenna when transmitting a signal may be improved, e.g., by changing an input impedance at a second antenna to inhibit power dissipation of the signal in a receive path (including the second antenna and possibly one or more other components), which may reduce power dissipation in the receive path compared to not changing the input impedance (e.g., that is provided by a receive chain connected to the second antenna). Inhibition of power dissipation by a receive path may be time aligned with time division multiplexing of the first antenna (e.g., between transmission and reception). Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

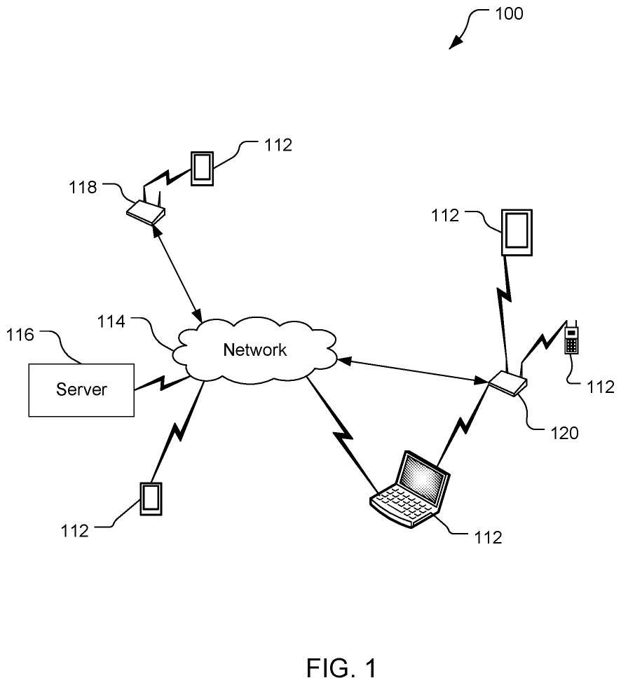

Referring to FIG. 1, a communication system 100 includes mobile devices 112, a network 114, a server 116, and access points (APs) 118, 120. The communication system 100 is a wireless communication system in that components of the communication system 100 can communicate with one another (at least some times) using wireless connections directly or indirectly, e.g., via the network 114 and/or one or more of the access points 118, 120 (and/or one or more other devices not shown, such as one or more base transceiver stations). For indirect communications, the communications may be altered during transmission from one entity to another, e.g., to alter header information of data packets, to change format, etc. The mobile devices 112 shown are mobile wireless communication devices (although they may communicate wirelessly and via wired connections) including mobile phones (including smartphones), a laptop computer, and a tablet computer. Still other mobile devices may be used, whether currently existing or developed in the future. Further, other wireless devices (whether mobile or not) may be implemented within the communication system 100 and may communicate with each other and/or with the mobile devices 112, network 114, server 116, and/or APs 118, 120. For example, such other devices may include internet of thing (IoT) devices, medical devices, home entertainment and/or automation devices, automotive devices, etc. The mobile devices 112 or other devices may be configured to communicate in different networks and/or for different purposes (e.g., 5G, Wi-Fi communication, multiple frequencies of Wi-Fi communication, satellite communication and/or positioning, one or more types of cellular communications (e.g., GSM (Global System for Mobiles), CDMA (Code Division Multiple Access), LTE (Long-Term Evolution), etc.), Bluetooth® communication, etc.).

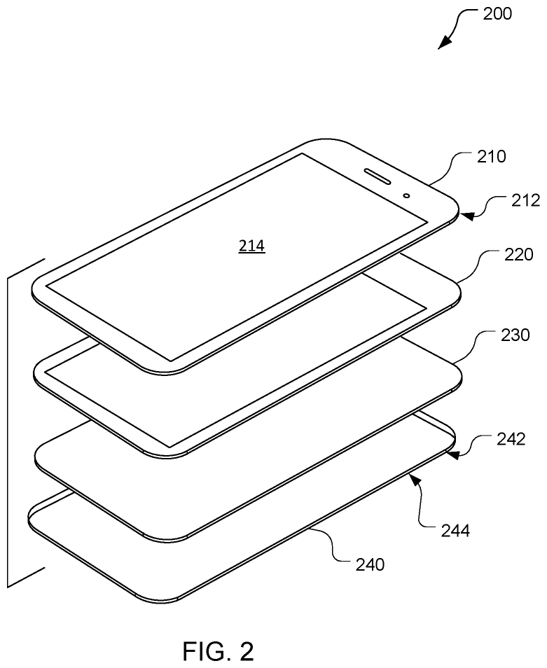

Referring to FIG. 2, a mobile device 200, which is an example of one of the mobile devices 112 shown in FIG. 1, includes a top cover 210, a display layer 220, a printed circuit board (PCB) layer 230, and a bottom cover 240. The mobile device 200 as shown may be a smartphone or a tablet computer but embodiments described herein are not limited to such devices (for example, in other implementations of concepts described herein, a device may be a router or customer premises equipment (CPE)). The top cover 210 includes a screen 214. The bottom cover 240 has a bottom surface 244. Sides 212, 242 of the top cover 210 and the bottom cover 240 provide an edge surface. The top cover 210 and the bottom cover 240 comprise a housing that retains the display layer 220, the PCB layer 230, and other components of the mobile device 200 that may or may not be on the PCB layer 230. For example, the housing may retain (e.g., hold, contain) or be integrated with antenna systems, front-end circuits, an intermediate-frequency circuit, and a processor discussed below. The housing may be substantially rectangular, having two sets of parallel edges in the illustrated embodiment, and may be configured to bend or fold. In this example, the housing has rounded corners, although the housing may be substantially rectangular with other shapes of corners, e.g., straight-angled (e.g., 45°) corners, 90°, other non-straight corners, etc. Further, the size and/or shape of the PCB layer 230 may not be commensurate with the size and/or shape of either of the top or bottom covers or otherwise with a perimeter of the device. For example, the PCB layer 230 may have a cutout to accept a battery. Further, the PCB layer 230 may include sandwiched boards and/or a PCB daughter board. Daughter boards may be chosen to facilitate a design and/or manufacturing process, e.g., to reinforce a functional separation or to better utilize a space in the housing. Embodiments of the PCB layer 230 other than those illustrated may be implemented.

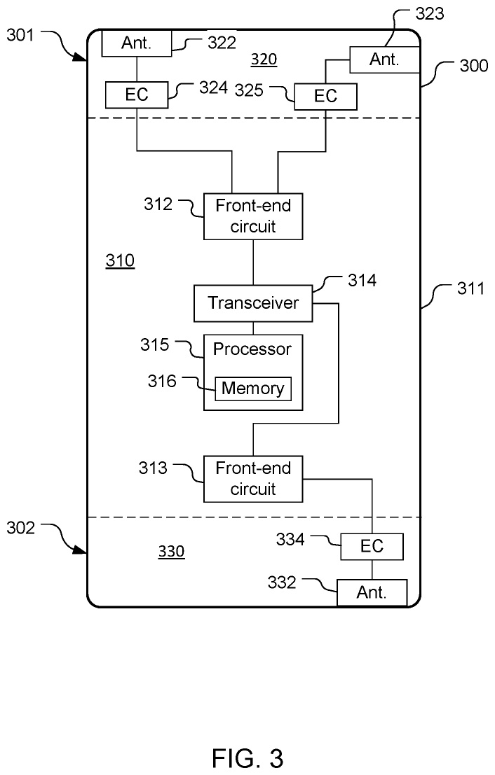

Referring also to FIG. 3, a PCB layer 300, which is an example of the PCB layer 230, includes a main portion 310 and a portion comprising antenna systems 320, 330. In the example shown, the antenna systems 320, 330 are disposed at opposite ends 301, 302 of the PCB layer 300, but one or both of the antenna systems 320, 330 may be disposed elsewhere, e.g., along a side edge of the PCB layer 300. The antenna system 320 includes antennas 322, 323 each including one or more antenna elements and may include energy couplers 324, 325 coupled to the antennas 322, 323, respectively, and configured to convey energy to and/or from the antennas 322, 323 from and/or to the main portion 310. The energy couplers 324, 325 may be specific or even custom components to convey energy to/from the antennas 322, 323 and/or may be transmission lines or portions thereof. The antenna system 330 includes an antenna 332 including one or more antenna elements and one or more energy couplers 334 coupled to the antenna 332 and configured to convey energy to and/or from the antenna 332 from and/or to the main portion 310. The antenna 322, the antenna 323, and/or the antenna 332 may comprise an array of antenna elements that may be configured for beamforming. The main portion 310 comprises a PCB 311 that includes front-end circuits 312, 313 (also called radio frequency (RF) circuits), a transceiver 314, and a processor 315 including memory 316. The memory 316 may be a non-transitory, processor-readable storage medium that includes software with processor-readable instructions that are configured to cause the processor 315 to perform functions (e.g., possibly after compiling the instructions). The processor 315 may be implemented as a modem or a portion thereof. The front-end circuits 312, 313 may be configured to provide signals to be radiated by the antenna systems 320, 330 and/or to receive and process signals that are received by, and provided to the front-end circuits 312, 313 from, the antenna systems 320, 330. One or more of the front-end circuits 312, 313 include one or more switches (e.g., as part of one or more multiplexers) for selectively coupling a respective energy coupler 324, 325, 334 to a desired termination (of a desired impedance), as discussed further herein. The front-end circuits 312, 313 may be configured to process (e.g., amplify, route, filter, etc.) RF signals received from the transceiver 314 or the antennas 322, 323, 332, for example without significantly adjusting a frequency thereof. In some examples, the antennas 322, 323, 332 are configured for operation with sub-6 (or sub-7) frequencies, for example in the range of 1.8 GHz-5 GHz. The front-end circuits 312, 313, however, may be configured in some examples to convert received IF signals from the transceiver 314 to RF (Radio Frequency) signals (amplifying with a power amplifier and/or phase shifting signals, for example when coupled to an antenna array, as appropriate), and provide the RF signals to the antenna systems 320, 330 for radiation. Similarly, the front-end circuits 312, 313 may be configured to convert RF signals received by the antenna systems 320, 330 to IF signals (e.g., using a low-noise amplifier and a mixer) and to send the IF signals to the transceiver 314. The transceiver 314 may be configured in these examples to convert IF signals received from the front-end circuits 312, 313 to baseband signals and to provide the baseband signals to the processor 315. The transceiver 314 may also be configured to convert baseband signals provided by the processor 315 to IF signals, and to provide the IF signals to the front-end circuits 312, 313. The processor 315 is communicatively coupled to the transceiver 314, which is communicatively coupled to the front-end circuits 312, 313, which are communicatively coupled to the antenna systems 320, 330.

In FIG. 3, dashed lines separating the antenna systems 320, 330 from the PCB 311 indicates functional separation of the antenna systems 320, 330 (and the components thereof) from other portions of the PCB layer 300. Portions of the antenna systems 320, 330 may be integral with the PCB 311, being formed as integral components of the PCB 311. One or more components of the antenna systems 320, 330 may be formed integrally with the PCB 311, and one or more other components may be formed separate from the PCB 311 and mounted to the PCB 311, or otherwise made part of the PCB layer 300 (e.g., on a PCB daughter board). Alternatively, the antenna systems 320, 330 may be formed separately from the PCB 311 and coupled to the front-end circuits 312, 313. In some examples, one or more components of either of the antenna systems 320, 330 may be integrated with the front-end circuits 312, 313, e.g., in a single module or on a single circuit board separate from the PCB 311. For example, the front-end circuits 312, 313 may be physically attached to the antenna systems 320, 330, e.g., attached to back sides of respective ground planes of the antenna systems 320, 330. Antennas of the antenna systems 320, 330 may have front-end circuitry electrically (conductively) coupled and physically attached to the antennas while another antenna may have the front-end circuitry physically separate, but electrically coupled to the other antenna.

When one of the antennas 322, 323, 332 is transmitting (e.g., in a transmit portion of a TDD (time division duplex) mode), transmit (Tx) power absorption of each coupled receive (Rx) antenna (e.g., in a terminating impedance such as an LNA (low noise amplifier)) can be reduced or avoided by detuning the receive antenna. The receive antenna may be detuned by, for example, providing a detuning impedance (e.g., a highly-reflective impedance) to the receive antenna. The detuning impedance may be provided by, e.g., shorting the receive antenna to ground for a short-circuit impedance, or disconnecting the receive antenna or connecting the antenna to an open-circuit impedance, or connecting the antenna to a detuning impedance of an intermediate impedance (e.g., −50j or +50j) between a short-circuit impedance and an open-circuit impedance. To detune an antenna in TDD mode, SRS (Sounding Reference Signal) switches, ASDiv (Antenna Switch Diversity) switches, (switches in) DRx (diversity receive) modules, (switches in) ASMs (Antenna Switch Modules), and/or Integrated Antenna Switches (IAS), for example, may be used when supporting an isolation mode or shorting.

What detuning impedances work (or work best) for a particular transmission (e.g., transmission by a particular antenna or antennas with one or more particular parameters, e.g., transmission frequency, which antenna(s) to detune, etc.) may vary. Because the impedance of a connected termination is transformed due to the path length of transmission line between the termination and the corresponding antenna, and due to any components between the termination and the antenna, knowing the resulting input impedance for the antenna may be difficult without measurement. Desirable antenna terminations (e.g., detuning impedances of a short-circuit impedance, an open-circuit impedance, or an intermediate impedance (e.g., −50j or +50j)) for one or more antennas under various transmission conditions (transmitting antenna(s), transmit signal frequency, transmission technology, etc.) may be determined by changing transmission parameters, connecting different terminations of different detuning impedances to one or more antennas, and measuring the gain and/or TRP (Total Radiated Power) of the transmission for each of the terminations for different combinations of the transmission parameters. The desirable termination for each antenna that may couple to the transmit antenna(s) for each combination of transmission parameters may be stored in a look-up table (LUT), e.g., in the memory 316 of the processor 315. A detuning framework, e.g., for TDM (time division multiplexing such as TDD), may be stored in the memory 316 for various RF-front-end architectures.

TDM detune switching may be time aligned with communication units, e.g., frames such as LTE (Long Term Evolution), and uplink/downlink (UL/DL) subframes. The LTE frames are 10 ms long and the UL/DL subframes are 1 ms long, and switching time between transmission and reception is about 25 μs (microseconds). Using ASDiv switches or ASM (Antenna Switch Module) switches can provide sufficiently quick switching (e.g., about 2 μs) to detune the receive antennas to avoid or reduce power dissipation by a receive antenna (and downstream receive circuitry). For an antenna selectively coupled to a transmitter or a receiver by a diplexer, the detuning switching can be provided “behind” the diplexer, i.e., between the diplexer and the receiver, to provide detuning without affecting other paths sharing the antenna (e.g., for SCC1 (Secondary Component Carrier 1), SCC2, EN-DC (E-UTRAN (Evolved Universal Mobile Telecommunications System Terrestrial Radio Access Network) New Radio-Dual Connectivity), WiFi®, GNSS (Global Navigation Satellite System, etc.)). Detuning using ASDiv and/or ASM switches behind the diplexer is fast enough for TDD detune.

Detuning an antenna not being used for transmission (e.g., an antenna not currently transmitting or an antenna for a receive-only function such as receiving GNSS signals) may be used to reduce or avoid absorbing power of a transmit signal in an antenna (and other circuitry) that is not in use. Detuning may provide an impedance at the out-of-use antenna that reflects the incoming transmit signal and/or inhibits reception/absorption of the transmit signal. To inhibit power absorption, the input impedance presented by the receive antenna should be far from a complex conjugate of the impedance of the receive antenna. Detuning can be performed by terminating a receive path anywhere downstream from a receive antenna, but terminating the receive path closer to the receive antenna helps reduce power loss, e.g., due to transmission line resistance and losses in any intervening components (e.g., circuitry).

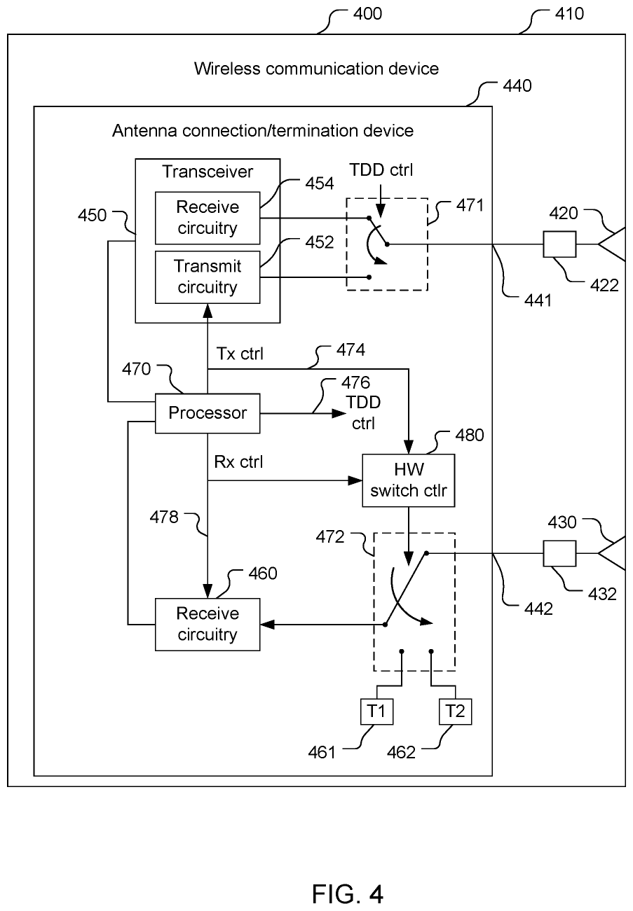

Referring also to FIG. 4, a wireless communication device 400 includes a housing 410, antennas 420, 430, and an antenna connection/termination device 440. The antennas 420, 430 may be examples of, e.g., the antennas 322, 332, and intermediate circuitry 422, 432 may be examples of the energy couplers 324, 334 and/or other components. The antenna connection/termination device 440 may be an example of the front-end circuits 312, 313, the transceiver 314, and the processor 315 (including the memory 316). For example, a transceiver 450 and receive circuitry 460 may be portions of the transceiver 314 in some examples; a processor 470 may be an example of the processor 315; and switches 471, 472, a hardware switch controller 480, and a first termination 461 and a second termination 462 may be examples of at least portions of the front-end circuits 312, 313. Components of the device 440 may be physically separate and spaced apart from each other, e.g., in different physical modules. For example, the hardware switch controller 480, the switch 472, and the terminations 461, 462 may be disposed in a module (e.g., an ASM) that is separate from the processor 470 and the receive circuitry 460. As another example, the switch 471 may be disposed in a module (e.g., an ASM) that is separate from the transceiver 450. In yet other examples, the transceiver 450, the receive circuitry 460, and/or portions thereof may be disposed in a module with the switches 471, 472. For example, the receive circuitry 454 and/or the receive circuitry 460 may include an LNA which is implemented separately from the transceiver 314, e.g., in a module with the switch 471 and/or the switch 472, respectively. The device 440 includes antenna ports 441, 442 configured to be communicatively coupled to the antennas 420, 430, e.g., through the intermediate circuitry 422, 432 (e.g., one or more filters, etc.), respectively. The ports 441, 442 may be physical connectors (e.g., if the device 440 is a standalone unit or module, or the switches 471, 472 are components of one or more modules) or may be virtual ports, e.g., arbitrary points along transmission lines connecting the device 440 to the antennas 420, 430 (or to the intermediate circuitry 422, 432). The wireless communication device 400 may, for example, be a smartphone, a tablet computer, a portion of a portable computer (e.g., a display portion or a base portion of a folding laptop computer), a router, a CPE, etc.

The device 400 is an example, and other configurations may be used. For example, one or more further antennas may be included in the device 400. Each of the antennas 420, 430, and/or any other antenna, may be representative of one or more antenna elements (for example, an antenna array). Each of the antennas 420, 430 may be a portion of a respective antenna module that includes a feed structure (e.g., one or more energy couplers) and/or additional antennas. Each of the antennas 420, 430 includes one or more antenna elements configured to transduce wireless signals into another form of signal (e.g., from free-space wireless to guided wireless, or from wireless to wired, etc.). The antennas 420, 430 may each be any of a variety of antennas, with one or more antenna elements of any of a variety of types of antenna elements, e.g., PIFAs (Planar Inverted-F Antennas), patches, horns, open-ended waveguides, substrate-integrated waveguides, wireline elements, monopoles, dipoles, loops, helixes, lenses, microstrips with resonant stubs, slotlines with resonant stubs, etc. While the antennas 420, 430 are communicatively coupled to respective switches 471, 472, and to the transceiver 450 and the receive circuitry 460, respectively, one or more of the antennas 420, 430 may be coupled to more than one transceiver, more than one transmit circuit, or more than one receive circuit, or combinations thereof. Similarly, a single transceiver, a single transmit circuit, and/or a single receive circuit may be communicatively coupled to multiple antennas. The wireless communication device 400 may be referred to by other terms, e.g., an access terminal (AT), a client device, a wireless device, a subscriber device, a subscriber terminal, a subscriber station, a user terminal (UT), a user equipment (UE), a mobile terminal, a mobile station (MS), a mobile device, etc.

The antenna connection/termination device 440 is configured to selectively couple the antenna 420 to transmit circuitry 452 or receive circuitry 454 of the transceiver 450 and to selectively couple the antenna 430 to the receive circuitry 460 or to the first termination 461 or the second termination 462. The switch 471, under control of the processor 470, is configured to selectively couple the antenna 420 to the transmit circuitry 452 or the receive circuitry 454. The switch 472, under control of the processor 470, is configured to selectively couple the antenna 430 to the receive circuitry 460 or to one of the terminations 461, 462. While in the example of the wireless communication device 400 shown there is no transmit circuitry available for the antenna 430, other example configurations are possible including configurations where transmit circuitry may be connected to the antenna 430. Also or alternatively, one or more further antennas may be present in the device 400 than shown, and one or more of the one or more further antennas may be selectively coupled to receive circuitry or a termination, or may be selectively coupled to receive circuitry, transmit circuitry, or a termination. Also or alternatively, while multiple terminations are shown, a single termination, e.g., the termination 461, may be used. The terminations 461, 462 have different impedances and a different impedance than the receive circuitry 460 such that coupling the receive circuitry 460 or one of the terminations 461, 462 to the antenna 430 will present different input impedances from free space into the antenna 430, which will result in different coupling from the antenna 420 to the antenna 430 during transmission by the antenna 420. While not illustrated, more than one transmit circuitry may be included (e.g., where another transmit circuitry is coupled to the antenna 430 or to an antenna not shown in FIG. 4). In some such examples, the switch 471, under control of the processor 470, may further be configured to selectively couple the antenna 420 to one or more terminations (not illustrated).

The processor 470 is communicatively coupled to the transceiver 450 and configured to provide a transmit signal to the transceiver 450, to receive a receive signal from the transceiver 450 and to provide one or more indications of transceiver operation. The indication(s) of transceiver operation include one or more transmit control signals 474 and one or more TDD control signals 476 (time division duplex control signals). The transmit control signal(s) 474 provide one or more indications of transceiver operation (i.e., one or more indications of signal transmission), e.g., one or more transmission parameters such as which transmit circuitry is operational (e.g., if there is more than one possible transmit circuitry) and thus a transmitting antenna or antennas (e.g., with separate transmitting antennas corresponding to separate transmit circuitry), transmission frequency, and/or transmission timing (e.g., for time division multiplexed (TDM) transmission such as TDD transmission). The transmit control signal(s) 474 may indicate coded transmission parameter(s) (i.e., parameter values), e.g., with different sets of transmission parameters corresponding to coded values (e.g., a four-bit code representing up to 16 different sets of transmission parameters (with a set possibly consisting of a single transmission parameter). Alternatively, the processor 470 may analyze transceiver operation (e.g., the indication(s) of transceiver operation) to determine the termination(s) to be used by one or more antennas and the transmit control signal(s) 474 may indicate the termination(s) to be used (e.g., without the one or more indications of transceiver operation). For example, the processor 470 may consider multiple-transmission conditions such as multi-SIM (multiple Subscriber Identity Module) operation, DSDA (Dual SIM Dual Active) operation, multi-RAT (e.g., WiFi and Bluetooth®) operation, etc. to select what information to provide in the control signal(s) 474. The control signal(s) 474 may provide less information than the full transceiver operation, and the hardware switch controller 480 may use a map (e.g., loaded upon call setup) of such information to termination(s) to be used in order to couple the antenna port 442 to the receive circuitry or to one of the terminations 461, 462. In some examples, the control signal 474 includes (only) an indication of which of the terminations 461, 462 to use when triggered; this value or indication may be stored in a register of the hardware switch controller 480 and used to connect the antenna 430 to an appropriate termination in response to a trigger without the hardware switch controller 480 having knowledge of or performing any determinations with respect to frequencies being used, which other antennas are active, etc. In some examples, the control signal(s) 474 may include an indication that the switch 472 should remain open and/or that no change in operation of the switch 472 should be effected in response to the trigger. In some examples, the control signal(s) 474 may fully describe the transceiver operation, but be sent less frequently than if less information is included in the control signal(s) 474. The control signal(s) 474 may provide different amounts of information at different times. For example, the control signal(s) 474 may include a thorough (e.g., full) description of transceiver operation at a first time, and provide less transceiver operation information at another time (e.g., with less information possibly provided multiple times between transmissions of the thorough description of transceiver operation). The TDD control signal(s) 476 indicate timing of switching between transmit and receive operations for the transceiver 450, and thus the antenna 420. The TDD control signal(s) 476 cause the switch 471 to switch between coupling the antenna port 441 (and thus the antenna 420) to the transmit circuitry 452 and coupling the antenna port 441 to the receive circuitry 454.

The processor 470 is communicatively coupled to the receive circuitry 460 and the hardware switch controller 480 for controlling the switch 472. The transmit control signal(s) 474 may serve as a detune enable to enable the controller 480 to actuate the switch 472 to selectively couple the antenna port 442 (and thus the antenna 430) to one of the terminations 461, 462. The hardware switch controller 480 is communicatively coupled to the processor 470 and the switch 472 and configured to control the switch 472 to selectively couple the antenna port 442 to the receive circuitry 460 or to one of the terminations 461, 462, based on the one or more indications of transceiver operation provided by the transmit control signal(s) 474. The hardware switch controller 480 may use information from the transmit control signal(s) 474 to determine operation of the switch 472, e.g., to determine to which of the terminations 461, 462 to couple to the antenna port 442. The processor 470 may provide one or more receive control signals 478 to the receive circuitry 460 and the hardware switch controller 480. The receive control signal(s) 478 may include a disable signal such as an LNA disable signal to disable an LNA of the receive circuitry or an ASM (antenna switch module) disable signal to disable an entire ASM that includes the receive circuitry 460. The disable signal of the receive control signal(s) 478 may be used as a trigger by the hardware switch controller 480 to cause the switch 472 to de-couple the receive circuitry 460 from the antenna port 442, e.g., and to couple the antenna port 442 to one of the terminations 461, 462.

The hardware switch controller 480 and the switch 472 are configured to provide sufficiently-quick switching to be time aligned or time synchronized with TDM switching of the transceiver 450 and the switch 471. The controller 480 comprises hardware logic that is configured to respond to the transmit control signal(s) 474 (e.g., an indication of which antenna will be transmitting, timing of transmission, and/or frequency of transmission, etc.) by determining which termination to couple to the antenna port 442 and to actuate the switch 472 to implement the determined coupling. The controller 480 may determine the desired coupling and implement the desired coupling in response to a trigger such as an indication to disable a receive path corresponding to the antenna port 442, such as a disable LNA indication of the receive control signal(s) 478, or a disable ASM signal indicating to disable an entire ASM containing the receive circuitry 460 (and that may include the switches 471, 472 and possibly one or more other switches). An ASM may include some or all of the receive circuitry 460 (e.g., an LNA of the receive circuitry 460). The controller 480 may cause the switch 472 to couple a termination to the antenna port 442 (only) if detuning is presently enabled (e.g., by a dedicated detune enable signal from the processor 470, or based on one or more of the transmit control signal(s) 474, etc.). The controller 480 may be configured to semi-autonomously implement detuning, e.g., responding to a trigger by determining and implementing desired detuning. For example, if detuning has been enabled, the controller 480 may respond to a disable receive chain indication (e.g., disable LNA) by accessing a look-up table and determining a desired detuning termination based on one or more transmission parameters (e.g., indicated by the transmit control signal(s) 474), and by causing the switch 472 to couple the antenna port 442 to the desired detuning termination. Selecting the best available detuning termination may improve gain and/or TRP of a transmitting antenna, with the amount of gain and/or TRP improvement depending upon the amount of coupling of the transmit and receive antennas without detuning, and the mismatch of the impedance of the transmit antenna and the receive antenna with the detuning implemented. For example, experimental results have indicated that for antennas with coupling (an S21) of −8 dB, −10 dB, and −12 dB, gain may be increased relative to a 50Ω termination by up to 0.8 dB, up to 0.4 dB, and up to 0.25 dB, respectively. The look-up table with desired detuning terminations may be the same for similarly designed wireless communication devices based on the design of the device and/or testing using one or more example devices, or may be based on measurements during manufacture of each wireless communication device. A desired termination may be a specific termination (with a specific impedance value), or may be an indication not to change a present termination. This may be the case, for example, when short transmit bursts are implemented, e.g., for measurements, such as during special subframes.

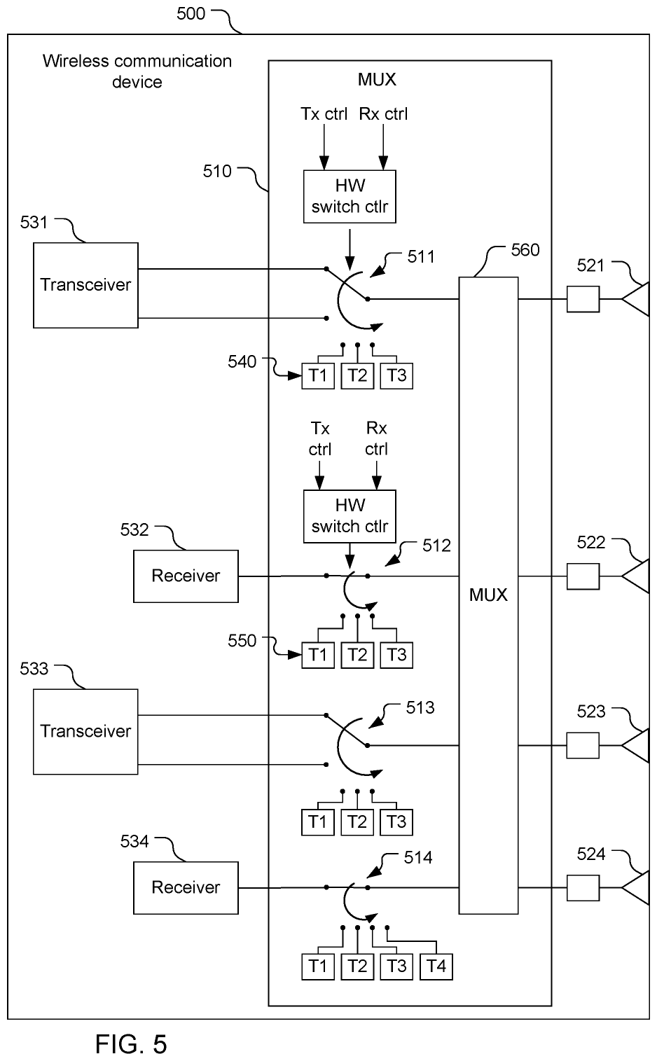

Other configurations of the wireless communication device 400 are possible. For example, transmit circuitry may be provided for the antenna 430 and the switch 472 may be operated to selectively couple the antenna port 442 to the receive circuitry 460, the transmit circuitry for the antenna 430, or one of the terminations 461, 462. As another example, one or more further antennas may be provided that are each selectively connected to respective receive circuitry, or (possibly) respective transmit circuitry, or one or more respective terminations. Other quantities of terminations may be available for coupling to an antenna (e.g., as shown in FIG. 5). Still other configurations are possible. As another example, in some scenarios, e.g., UL-MIMO (Uplink Multiple Input Multiple Output) or EN-DC, multiple transmit antennas may transmit signals concurrently, e.g., from respective transmit circuitry. The gain of one or more of these transmit antennas may benefit from detuning of one or more coupled antennas. As another example, one or more frequency bands (e.g., PCC (Primary Component Carrier) and/or SCC (Secondary Component Carrier)) and one or more receive/antenna paths may be determined for implementing a call. Which component carrier(s) and/or which receive/antenna paths is(are) selected may affect which termination(s) is(are) connected to one or more respective antennas. As another example, there may be exceptions to when detuning is implemented for a first antenna while a transmit signal is transmitted by a second antenna (e.g., where there is little or no coupling between the antennas (e.g., due to frequency of transmission and frequency range for which the first antenna is designed)). For example, the processor 470 may determine that an exception is present, and thus not send any of the control signal(s) 474 to cause a detuning of any antennas, or may send a control signal 474 to disable or turn off detuning, or may send a control signal 474 indicating that switch operation should remain constant in response to a trigger (e.g., remain open). As another example, the hardware switch controller 480 may determine (e.g., from a mapping of transceiver conditions to detuning actions, if any) not to detune in response to one or more exceptions to detuning being present as indicated by the control signal(s) 474.

Referring also to FIG. 5, another example wireless communication device 500 includes a MUX 510 (multiplexer) configured to selectively couple antennas 521, 522, 523, 524 to respective transceivers 531, 533 and receivers 532, 534. The antenna 521 may be selectively coupled via a MUX 560 and a switch 511 to a transmitter or a receiver of the transceiver 531, or to any of three terminations 540. For example, the antenna 521 may be coupled to one of the terminations 540 while the antenna 523 is being used to transmit signals. The antenna 522 may be selectively coupled via the MUX 560 and a switch 512 to the receiver 532, or to any of three terminations 550. The terminations 550 may include, e.g., a short circuit, an open circuit, and an intermediate impedance that is between the impedance of a short circuit and the impedance of an open circuit. Each of the antennas 521-524 may be coupled to a respective one of the transceivers 531, 533 or the receivers 532, 534, or to a respective termination, e.g., being coupled to a termination while another antenna is transmitting, via the MUX 560 and a respective switch 511, 512, 513, 514. The MUX 560 in combination with one or more (as appropriate) of the switches 511-514 may couple any of the antennas 521-524 to one or more of the transceivers 531, 533 and/or one or more of the receivers 532, 534. Similarly, the MUX 560 in combination with one or more (as appropriate) of the switches 511-514 may couple any of the transceivers 531, 533 or any of the receivers 532, 534 to one or more of the antennas 521-524. The MUX 560 is optional, e.g., the antennas 521-524 (or respective intermediate circuitry) may be coupled to the switches 511, 514, respectively. The MUX 510 and possibly portions of one or more of the transceivers 531, 533 and/or possibly portions of one or more of the receivers 532, 534 may be disposed in an ASM.

Configurations of wireless communication devices other than that shown in FIG. 5 are possible. For example, different antennas may have different termination impedances available for coupling. Thus, while in FIG. 5, the antennas 521 and 522 both have terminations T1, T2, T3 available, in other configurations, different antennas may share some but not all of the termination values (e.g., the antenna 521 having terminations T1, T2, T3 available and the antenna having terminations T1, T2, T4 available), or may share no termination values (e.g., the antenna 521 having terminations T1, T2, T3 available and the antenna 522 having terminations T4, T5 available).

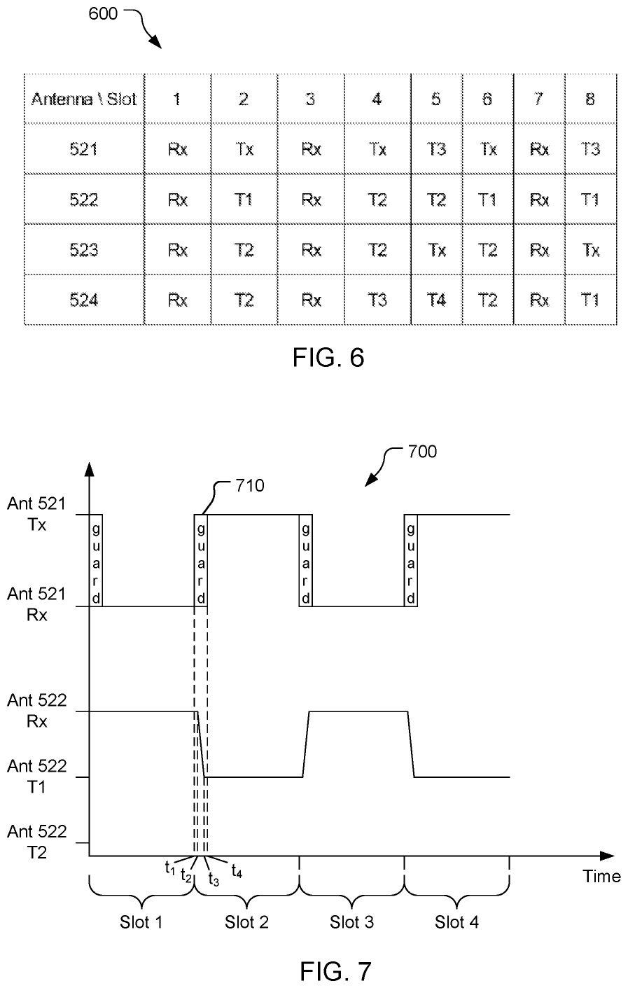

Referring also to FIG. 6, the antennas 521-524 may be selectively coupled to respective circuitry or terminations as shown in a timing chart 600. In this example, during slots 1 and 3 all the antennas are receiving and thus connected to respective receivers. During slot 2, the antenna 521 is transmitting and the antennas 522-524 are connected to terminations T1, T2, T2, respectively. During slot 4, the antenna 521 is transmitting and the antennas 522-524 are coupled to terminations T2, T2, and T3, respectively. The antennas 522, 524 are coupled to different terminations while the antenna 521 is transmitting in slots 2 and 4. This may be due, e.g., to the antenna 521 transmitting signals of different frequencies in the two slots such that different terminations provide better reflective input impedances at the antennas 522, 524 during the different transmissions by the antenna 521. Still other configurations of wireless communication devices may be used.

Referring also to FIG. 7, a timing diagram 700 shows that the switching of terminations of a coupled antenna is time aligned with TDM slots, here TDD transmission/reception slots of another antenna. The terminations may be switched during a time guard 710 of a slot, such as during a Cyclic Prefix that occurs at the beginning of every LTE/5G NR slot. For example, a time guard extends from a time t₁ to a time t₄ for the antenna 521. The antenna 522 is transitioned between times t₂ and t₃ from being coupled to receive circuitry to being coupled to a termination T1. The time guard 710 completes at a time t₄, after the time t₃ such that the antenna 522 is connected to a termination before transmission of the transmit signal, and remains connected to the termination for the entire time that the transmit signal is transmitted (at least before the antenna 521 is used for another purpose such as receiving), here from the time t₄ until an end of slot 2. The switching of antenna terminations in response to TDM slots is time aligned in that the transition of the antenna 522 to a termination corresponding to a new mode is completed before (here at the time t₃) completion of the time guard 710 and transmission of a transmit signal (here, the Tx mode at the time t₄) such that there is no connection of an antenna to an LNA during transmission of the transmit signal.

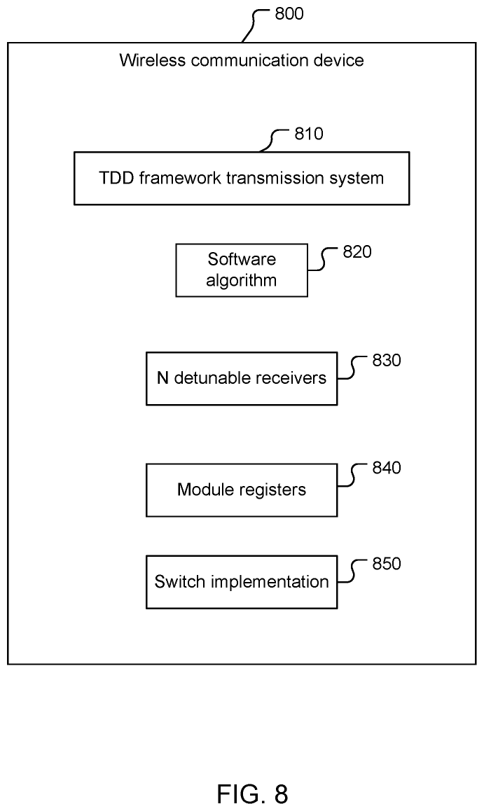

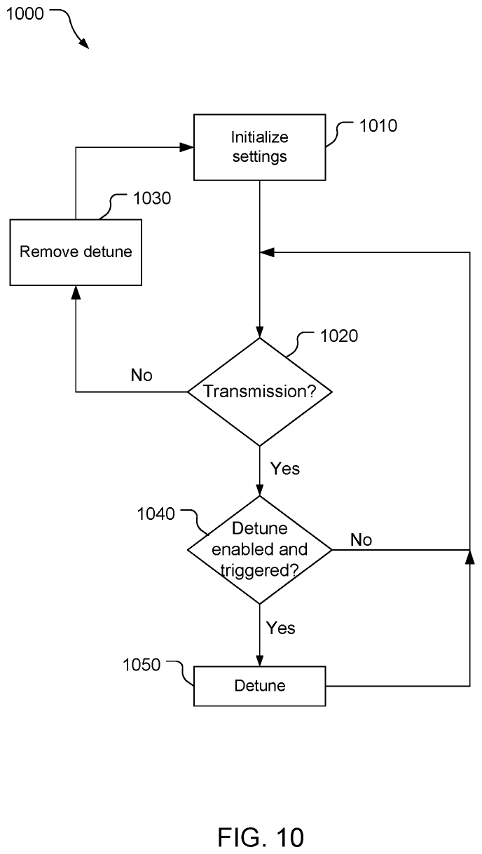

Referring also to FIG. 8, a wireless communication device 800, which is an example of the wireless communication device 400, includes elements for implementing TDM detuning, in this example, TDD detuning. The elements include a TDD framework transmission system 810, a software algorithm 820, N detunable receivers 830, module registers 840, and a switch implementation 850. The TDD framework transmission system 810 includes one or more components, corresponding to a TDD network in which the wireless communication device 800 operates, to implement TDD (e.g., the switch 471 and control thereof by the processor 470). The software algorithm is discussed further below with respect to FIG. 10 and is configured to determine whether to detune a receiver and to detune the receiver as appropriate. The software algorithm 820 is an example implementation and is not intended to be limiting; similar functionality may be implemented in firmware, hardware/circuitry, etc. instead, or with a combination thereof. The N detunable receivers 830 include one or more receivers each corresponding to a respective antenna for signal reception, or to a desired termination for providing an input impedance at the antenna to inhibit absorption of a transmit signal from a transmit antenna. The N detunable receivers 830 may be, for example, the receive circuitry 460, or the receivers 532, 534 and a receiver of the transceiver 533. The module registers 840 store the settings for implementing desired antenna connections. The switch implementation 850 is the physical implementation of the switches for implementing TDD and for selectively coupling a receive antenna to receive circuitry or to a desired termination.

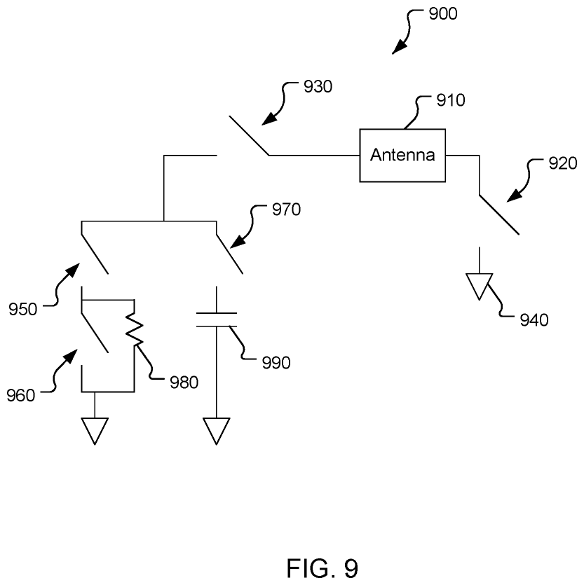

Referring to FIG. 9, with further reference to FIGS. 4 and 5, a switch implementation 900 is an example of selective coupling of an antenna to desired circuitry or a desired termination. In this example, the switch implementation 900 is configured to connect an antenna 910 to any of four detuning terminations with different detuning impedances, here an open-circuit impedance, a short-circuit impedance, a first intermediate impedance, or a second intermediate impedance. For the open state, switches 920, 930 are set to be open (as shown). For a short state, the switch 920 is closed (to connect the antenna 910 to ground 940) and the switch 930 is open, or the switch 920 is open, the switch 930 is closed, and switches 950, 960 are closed. For a first intermediate impedance state, the switches 920, 960 are open, a switch 970 is open, and the switches 930, 950 are closed, connecting the antenna 910 through a resistor 980 to ground. For a second intermediate impedance state, the switches 920, 950 are open, and the switches 930, 970 are closed, connecting the antenna 910 through a capacitor 990 to ground.

Referring to FIG. 10, with further reference to FIGS. 4 and 5, a method 1000 of semi-autonomous detuning (e.g., by the hardware switch controller 480) includes the stages shown. The method 1000 is, however, an example and not limiting. The method 1000 may be altered, e.g., by having stages added, removed, rearranged, combined, performed concurrently, and/or having single stages split into multiple stages. At stage 1010, module initialization is performed where antenna connection settings are set to values stored in memory. For example, the hardware switch controller 480 may receive settings from the modem and store the settings in a memory of the hardware switch controller 480, e.g., in a set of registers, etc. The hardware switch controller 480 may set the connection of the switch 472 to an initial connection in accordance with the settings. At stage 1020, an inquiry is made as to whether there is any signal transmission from any antenna other than an antenna to be detuned possibly, e.g., from the antenna 420 of the device 400. If not, then the method 1000 proceeds to stage 1030 where any detune connections are removed, after which the method 1000 returns to stage 1010. If there is (or will be) signal transmission (possibly indicated by disabling of a receive state), then the method 1000 proceeds to stage 1040 where an inquiry is made as to whether detuning is presently enabled and triggered. If not, then the method 1000 returns to stage 1020. If detuning is enabled and triggered, then the method 1000 proceeds to stage 1050 where detuning is implemented, e.g., by the controller 480 actuating the switch 472 to cause the antenna port 442 to be coupled to a desired one of the terminations 461, 462 (in accordance with the register settings established at stage 1010). The method 1000 returns to stage 1020 such that detuning can be continued until the transmission ends. Other methods of operation in accordance with various configurations described above are also possible. For example, stages 1020 and/or 1030 may be removed or collapsed into stage 1040 in some examples. In some such examples, the hardware switch controller 480 merely monitors for the trigger (e.g., by determining whether a certain LNA disable or module disable signal has been received or asserted), and applies the appropriate detune (from stage 1010). When the trigger is no longer satisfied (e.g., the LNA or module is enabled), the hardware switch controller 480 removes the detune.

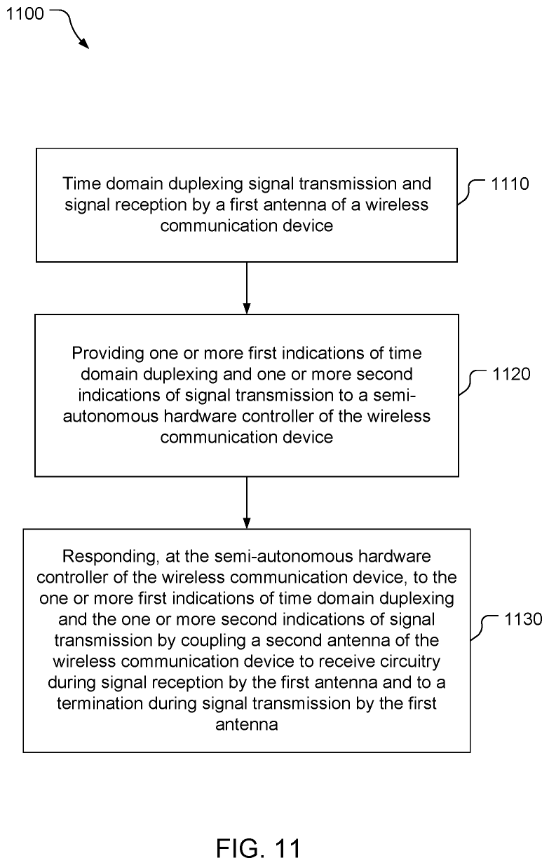

Referring to FIG. 11, with further reference to FIGS. 1-10, a method 1100 of antenna detuning includes the stages shown. The method 1100 is, however, an example and not limiting. The method 1100 may be altered, e.g., by having stages added, removed, rearranged, combined, performed concurrently, and/or having single stages split into multiple stages.

At stage 1110, the method 1100 includes time domain duplexing signal transmission and signal reception by a first antenna of a wireless communication device. For example, the transceiver 450 time domain duplexes signal transmission from the transmit circuitry 452 through the switch 471, the antenna port 441, the intermediate circuitry 422 and the antenna 420, and signal reception in the receive circuitry 454 from the switch 471, the antenna port 441, the intermediate circuitry 422 and the antenna 420. The transceiver 450, in combination with the switch 471, may comprise means for time domain duplexing signal transmission and signal reception by a first antenna.

At stage 1120, the method 1100 includes providing one or more first indications of time domain duplexing and one or more second indications of signal transmission to a semi-autonomous hardware controller of the wireless communication device. For example, the processor 470 provides the transmit control signal(s) 474 and the receive control signal(s) 478 indicating operation of the receive circuitry 460, which corresponds to timing of signal transmission by the transceiver 450, and transmission parameter(s) (e.g., frequency, antenna), coded transmission parameter(s), etc. The processor 470 (e.g., the processor 315 possibly in combination with the memory 316) may comprise means for providing one or more first indications of time domain duplexing and one or more second indications of signal transmission.

At stage 1130, the method 1100 includes responding, at the semi-autonomous hardware controller of the wireless communication device, to the one or more first indications of time domain duplexing and the one or more second indications of signal transmission by coupling a second antenna of the wireless communication device to receive circuitry during signal reception by the first antenna and to a termination during signal transmission by the first antenna. For example, the hardware switch controller 480 uses the timing of signal transmission and possibly one or more transmission parameters (coded parameter(s) or actual parameter(s) e.g., frequency and/or transmit antenna) by coupling the antenna port 442 to the receive circuitry 460 or to a termination, here one of the terminations 461, 462, e.g., to (e.g., best) reflect (from among possible terminations) the transmit signal that is incident upon the antenna 430.

Implementations of the method 1100 may include one or more of the following features. In an example implementation, the coupling of the second antenna to the receive circuitry and to the termination is time aligned with the time domain duplexing signal transmission and signal reception by the first antenna. For example, the antenna port 442 is coupled to one of the terminations 461, 462 for an entire time that the transmit signal is transmitted. In another example implementation, the coupling of the second antenna to the termination is in response to a disable signal indicating to disable the receive circuitry. For example, the hardware switch controller 480 may respond to a trigger signal such as an indication to disable an LNA of the receive circuitry 460 to couple the antenna port 442 to one of the terminations 461, 462. In another example implementation, the coupling of the second antenna to the termination is in response to a disable signal indicating to disable an antenna switch module of the wireless communication device. For example, the hardware switch controller 480 may respond to a trigger signal such as an indication to disable an entire ASM that includes the receive circuitry 460.

Also or alternatively, implementations of the method 1100 may include one or more of the following features. In an example implementation, the coupling of the second antenna to the termination comprises coupling the second antenna to one of a plurality of terminations based on the one or more second indications of the signal transmission, where the plurality of terminations correspond to a plurality of gains for the first antenna, and where the coupling of the second antenna to one of the plurality of terminations couples the second antenna to a selected one of the plurality of terminations with a highest one of the plurality of gains for the first antenna. For example, based on one or more transmission properties (e.g., transmit antenna and/or transmit frequency, etc.), the hardware switch controller 480 may selectively couple the antenna port 442 to the termination 461, 462 that results in a best gain for the antenna 420 (best from the possible gains corresponding to the terminations 461, 462). As another example, based on one or more transmission properties (e.g., transmit antenna and/or transmit frequency, etc.), a hardware switch controller corresponding to the antenna 524 may selectively couple the antenna 524 to the termination from the terminations T1, T2, T3, T4 that results in a best gain for the antenna 521 (best from the possible gains corresponding to the terminations T1, T2, T3, T4). In a further example implementation, the plurality of terminations include a short circuit, an open circuit, and an intermediate termination having an impedance between a short circuit impedance and an open circuit impedance.

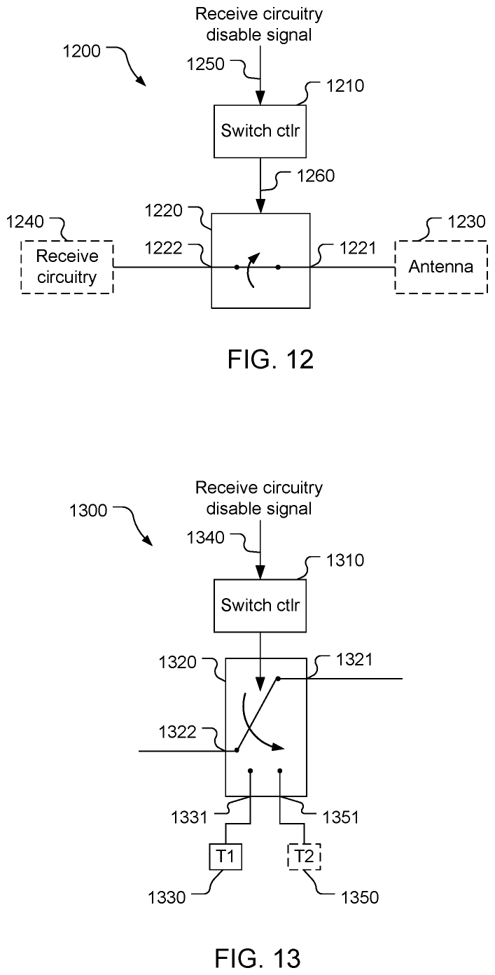

Referring to FIG. 12, with further reference to FIG. 4, an antenna switch apparatus 1200 includes a switch controller 1210 and a switch 1220. The switch controller 1210 may be, for example, a hardware switch controller similar to the hardware switch controller 480. The switch controller 1210 is communicatively coupled to the switch 1220 and the switch controller 1210 and the switch 1220 are configured to provide sufficiently-quick switching to be time aligned or time synchronized with TDM switching of a transceiver and a corresponding switch (e.g., the transceiver 450 and the switch 471). The switch 1220 includes an antenna port 1221 that is configured to be communicatively coupled to an antenna 1230, and a receive port 1222 that is configured to be communicatively coupled to receive circuitry 1240. The ports 1221, 1222 may be physical connectors (e.g., if the antenna switch apparatus 1200 is a standalone unit or module, or the switch 1220 is a component of a module) or may be virtual ports, e.g., arbitrary points along transmission lines connecting the switch 1220 to the antenna 1230 (e.g., via intermediate circuitry) and the receive circuitry 1240. As shown, the switch 1220 is a single pole, single throw switch that can connect the antenna port 1221 to the receive port 1222 or disconnect the antenna port 1221 from the receive port 1222.

The switch controller 1210 is communicatively coupled to the switch 1220 and configured to control the switch 1220 to selectively couple the antenna port 1221 to the receive port 1222 or decouple the antenna port 1221 from the receive port 1222. For example, the switch controller 1210 may be configured to cause, in response to reception of a receive circuitry disable signal 1250, the switch 1220 to decouple the antenna port 1221 from the receive port 1222 switch by sending a control signal 1260 to the switch 1220. The receive circuitry disable signal 1250 may have a variety of content, such as an explicit instruction to decouple the ports 1221, 1222. As another example, the receive circuitry disable signal 1250 may comprise an implicit instruction to decouple the ports 1221, 1222 such as a receive circuitry disable signal (e.g., an LNA-disable signal, an ASM-disable signal, or another signal to disable one or more components of the receive circuitry 1240), or one or more indications of signal transmission by an antenna other than the antenna 1230. The switch 1220 may provide an open circuit impedance when the switch 1220 decouples the ports 1221, 1222.

Referring also to FIG. 13, an antenna switch apparatus 1300 includes a switch controller 1310, a switch 1320, and at least one termination impedance, here a termination impedance 1330. The switch controller 1310 is configured to cause the switch 1320 to couple an antenna port 1321 to a receive port 1322 for signal reception and processing. The switch controller 1310 is configured to control, in response to receiving a receive circuitry disable signal 1340, the switch 1320 to cause the switch 1320 to decouple the antenna port 1321 from the receive port 1322, e.g., to couple the antenna port to at least one termination port, here a termination port 1331 (that is communicatively coupled to the termination impedance 1330), or possibly to neither the receive port 1322 nor the termination port 1331. Other example antenna switch apparatus may include more than one termination impedance. For example, an embodiment of the antenna switch apparatus 1300 may include the termination impedance 1330 and a termination impedance 1350 that is communicatively coupled to a termination port 1351, and the switch 1320 may be configured to couple the antenna port 1321 to the receive port 1322 or to any of the termination ports 1331, 1351 for a respective one of the termination impedances 1330, 1350, or possibly to neither the receive port 1322 nor any of the termination ports 1331, 1351. A switch controller (e.g., the switch controller 1310) may be configured to cause a switch (e.g., the switch 1310) to couple an antenna port (e.g., the antenna port 1321) to a selected one of at least one termination port (e.g., the termination port 1331), and thus to a selected one of at least one termination impedance (e.g., the termination impedance 1330), in response to reception of a receive circuitry disable signal (e.g., the receive circuitry disable signal 1340). In an embodiment with multiple termination impedances (e.g., the termination impedances 1330, 1350), the switch controller 1310 may be configured to select which of multiple termination ports (e.g., the termination port 1331 and a termination port 1351 communicatively coupled to the termination impedance 1350) to have the switch 1320 couple to the antenna port 1321 based on one or more indications received by the switch controller 1310. For example, the one or more indications may include one or more indications of signal transmission, e.g., one or more transmission parameters of signal transmission by an antenna other than an antenna electrically coupled to the antenna port 1321. As another example, the one or more indications may include one or more call setup communications, or at least a portion of one or more call setup communications.

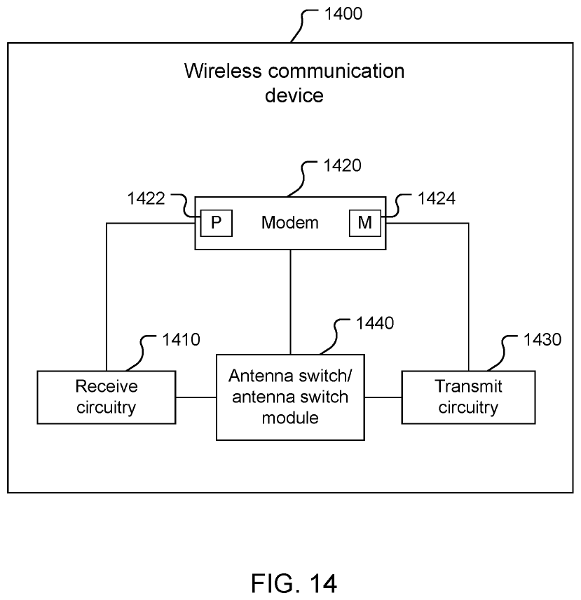

Referring to FIG. 14, with further reference to FIG. 4, a wireless communication device 1400, such as any of the wireless communication devices 400, 500, 800, includes receive circuitry 1410, a modem 1420, transmit circuitry 1430, and an antenna switch or antenna switch module 1440. The antenna switch or antenna switch module 1440 is communicatively coupled to the receive circuitry 1410, the modem 1420, and the transmit circuitry 1430. The modem 1420 includes a processor 1422 and is communicatively coupled to the receive circuitry 1410 and the transmit circuitry 1430, although the receive circuitry 1410 and the transmit circuitry 1430 may be disposed in a semiconductor chip that is physically separate from a system on a chip (SoC) that includes the modem 1420. The modem 1420 may modulate data packets into modulated data packets (e.g., at a baseband frequency) and provide the modulated data packets to the transmit circuitry 1430. The transmit circuitry 1430 may converted the modulated data packets into RF packets at radio frequencies and provide the RF packets to one or more antennas (e.g., the antenna 420) for transmission. The receive circuitry 1410 may receive RF data packets from one or more antennas (e.g., the antenna 430), and provide corresponding modulated data packets (e.g., at a baseband frequency) to the modem 1420 that can demodulate the modulated data packets. The transmit circuitry 1430 may be configured to transmit an outbound signal for transmission by one or more antennas of the wireless communication device 1400. The receive circuitry 1410 may be configured to receive an inbound signal from an antenna, of the wireless communication device 1400, that is distinct from the antenna(s) transmitting the outbound signal. The modem 1420 may comprise multiple, physically separate, devices. The modem 1420 may (similar to the processor 315) include the processor 1422 and memory 1424 containing processor-readable instructions that the processor may read and execute to perform appropriate modulating and/or demodulating functions.

The modem 1420 (e.g., the processor 1422) may be configured to transmit, at different times, first and second subsets of possible transmission parameter values, for the wireless communication device, to an antenna switch or antenna switch module 1440 of the wireless communication device 1400. The antenna switch or antenna switch module 1440 can selectively detune or re-detune, during a call, the antenna from which the inbound signal is received based on the first or second subsets of possible transmission parameter values, respectively. For example, there may be numerous possible transmission frequencies and/or transmission antennas (e.g., single transmission antenna (i.e., an antenna presently transmitting a signal although the same antenna may be used for signal reception) or combinations of transmission antennas). The modem 1420 may provide subsets of these corresponding to current use of the wireless communication device 1400 (e.g., which antenna(s) is(are) transmitting and at what frequency(ies)). The processor 1422 and the antenna switch or antenna switch module 1440 work together in some examples such that the processor 1422 determines a first subset of information such that the antenna switch or antenna switch module 1440 can efficiently connect the antenna as appropriate (e.g., to receive circuitry or to a detuning impedance) and the antenna switch or antenna switch module 1440 can implement the appropriate connection (e.g., detuning) without further direction from the processor until receipt of a second subset of information. The antenna switch or antenna switch module 1440 can detune an antenna and re-detune the antenna based on the one or more indications of disablement of the receive circuitry 1410.

The modem 1420 (e.g., the processor 1422) may transmit one or more indications of signal transmission on a slot-by-slot basis. For example, the modem 1420 may transmit the subset of values as a first indication of signal transmission corresponding to a first slot, transmit a second indication of lack of transmission (e.g., an indication of use of the transmit antenna(s) for reception) corresponding to a second slot, and transmit a third indication of signal transmission corresponding to a third slot. For example, the third indication may be simply an indication of signal transmission, without including the subset of parameter values, and the parameter values can be assumed to be the same as the most-recent subset of possible transmission parameter values sent by the modem 1420. As another example, the first indication and/or the third indication may be a coded indication of the subset of possible transmission parameter values.

The receive circuitry 1410, the transmit circuitry 1430, and the modem 1420 (e.g., the processor 1422) may be configured to perform TDD, alternating between signal transmission and signal reception. The modem 1420 may transmit one or more indications of signal transmission for each of multiple signal transmissions. For example, the one or more indications of signal transmission may include the subset of possible transmission parameter values (which may be a coded indication of the parameter values). As another example, the one or more indications of signal transmission may be independent of the possible transmission parameter values, e.g., may be a simple indication of signal transmission generally (e.g., a binary transmission/no transmission indication, or binary transmission/reception indication). The modem 1420 may transmit one or more indications of signal transmission disablement for each of multiple signal receptions (e.g., by the antenna used for the signal transmissions). For example, the one or more indications of signal transmission disablement may include one or more explicit indications of disablement of the receive circuitry 1410 (e.g., to disable the receive circuitry 1410 completely or to disable a component of the receive circuitry 1410).

### IMPLEMENTATION EXAMPLES

Implementation examples are provided in the following numbered clauses.

Clause 1. An antenna connection/termination device comprising:
a first antenna port configured to communicatively couple to a first antenna;
a first switch communicatively coupled to the first antenna port;
transceiver circuitry communicatively coupled to the first switch and including transmit circuitry and first receive circuitry, wherein the first switch is configured to selectively communicatively couple the first antenna port to the transmit circuitry or the first receive circuitry;
a second antenna port configured to communicatively couple to a second antenna;
a second switch communicatively coupled to the second antenna port;
second receive circuitry communicatively coupled to the second switch;
one or more terminations, having a corresponding one or more different impedances, wherein the second switch is configured to selectively communicatively couple the second antenna port to the second receive circuitry or one of the one or more terminations;
a processor communicatively coupled to the transceiver circuitry, the second receive circuitry, the first switch, and the second switch, and configured to provide one or more indications of transceiver operation including time-division multiplexing between operation of the transmit circuitry to transmit a transmit signal and operation of the first receive circuitry, and corresponding selective communicative coupling by the first switch of the first antenna port to the transmit circuitry or to the first receive circuitry; and
a hardware switch controller communicatively coupled to the processor and the second switch and configured to control the second switch to communicatively couple the second antenna port to a selected one of the one or more terminations based on the one or more indications of transceiver operation in accordance with the time-division multiplexing between operation of the transmit circuitry and operation of the first receive circuitry.

Clause 2. The antenna connection/termination device of clause 1, wherein the hardware switch controller and the second switch are configured such that the second switch changes between communicatively coupling the second antenna port to the second receive circuitry and communicatively coupling the second antenna port to one of the one or more terminations such that the second switch communicatively couples the second antenna port to one of the one or more terminations for a time duration that is time aligned with transmission of the transmit signal.

Clause 3. The antenna connection/termination device of any one of clauses 1 and 2, wherein the hardware switch controller is configured to actuate the second switch in response to a disable signal indicating to disable an amplifier of the second receive circuitry.

Clause 4. The antenna connection/termination device of any one of clauses 1 and 2, wherein the hardware switch controller is configured to actuate the second switch in response to a disable signal indicating to disable an antenna switch module.

Clause 5. The antenna connection/termination device of clause 1, wherein the one or more terminations correspond to a plurality of terminations that correspond to a plurality of gains for the first antenna, and wherein the hardware switch controller is configured to control the second switch to communicatively couple the second antenna port to the selected one of the plurality of terminations with a highest one of the plurality of gains for the first antenna.

Clause 6. The antenna connection/termination device of any one of clauses 1-5, wherein the one or more terminations include a short circuit, an open circuit, and an intermediate termination having an impedance between a short circuit impedance and an open circuit impedance.

Clause 7. An antenna detuning method comprising:
time domain duplexing signal transmission and signal reception by a first antenna of a wireless communication device;
providing one or more first indications of time domain duplexing and one or more second indications of signal transmission to a semi-autonomous hardware controller of the wireless communication device; and
responding, at the semi-autonomous hardware controller of the wireless communication device, to the one or more first indications of time domain duplexing and the one or more second indications of signal transmission by coupling a second antenna of the wireless communication device to receive circuitry during signal reception by the first antenna and to a termination during signal transmission by the first antenna.

Clause 8. The antenna detuning method of clause 7, wherein the coupling of the second antenna to the receive circuitry and to the termination is time aligned with the time domain duplexing signal transmission and signal reception by the first antenna.

Clause 9. The antenna detuning method of clause 7, wherein the coupling of the second antenna to the termination is in response to a disable signal indicating to disable the receive circuitry.

Clause 10. The antenna detuning method of clause 7, wherein the coupling of the second antenna to the termination is in response to a disable signal indicating to disable an antenna switch module of the wireless communication device.

Clause 11. The antenna detuning method of clause 7, wherein the coupling of the second antenna to the termination comprises coupling the second antenna to one of a plurality of terminations based on the one or more second indications of the signal transmission, wherein the plurality of terminations correspond to a plurality of gains for the first antenna, and wherein the coupling of the second antenna to one of the plurality of terminations couples the second antenna to a selected one of the plurality of terminations with a highest one of the plurality of gains for the first antenna.

Clause 12. The antenna detuning method of clause 11, wherein the plurality of terminations include a short circuit, an open circuit, and an intermediate termination having an impedance between a short circuit impedance and an open circuit impedance.

Clause 13. A wireless communication device comprising:
means for time domain duplexing signal transmission and signal reception by a first antenna of the wireless communication device;
means for providing one or more first indications of time domain duplexing and one or more second indications of signal transmission to a semi-autonomous hardware controller of the wireless communication device; and
means for coupling, in response to the one or more first indications of time domain duplexing and the one or more second indications of signal transmission, a second antenna of the wireless communication device to receive circuitry during signal reception by the first antenna and to a termination during signal transmission by the first antenna.

Clause 14. The wireless communication device of clause 13, wherein the means for coupling the second antenna to the receive circuitry and to the termination comprise means for coupling the second antenna to the receive circuitry and to the termination time aligned with the time domain duplexing signal transmission and signal reception by the first antenna.

Clause 15. The wireless communication device of clause 13, wherein the means for coupling the second antenna to the receive circuitry and to the termination comprise means for coupling the second antenna to the termination in response to receiving a disable signal indicating to disable the receive circuitry.

Clause 16. The wireless communication device of clause 13, wherein the means for coupling the second antenna to the receive circuitry and to the termination comprise means for coupling the second antenna to the termination in response to receiving a disable signal indicating to disable an antenna switch module of the wireless communication device.

Clause 17. The wireless communication device of clause 13, wherein the means for coupling the second antenna to the receive circuitry and to the termination comprise means for coupling the second antenna to one of a plurality of terminations based on the one or more second indications of the signal transmission, wherein the plurality of terminations correspond to a plurality of gains for the first antenna, and wherein the means for coupling the second antenna to the receive circuitry and to the termination comprise means for coupling the second antenna to a selected one of the plurality of terminations with a highest one of the plurality of gains for the first antenna.

Clause 18. The wireless communication device of clause 17, wherein the plurality of terminations include a short circuit, an open circuit, and an intermediate termination having an impedance between a short circuit impedance and an open circuit impedance.

Clause 19. An antenna switch apparatus comprising:
a switch controller;
at least one termination impedance; and
a switch communicatively coupled to the switch controller, the switch comprising an antenna port configured to be communicatively coupled to an antenna, a receive port configured to be communicatively coupled to receive circuitry, and at least one termination port each communicatively coupled to a respective one of the at least one termination impedance;
wherein the switch controller is configured to respond to reception of a receive circuitry disable signal by causing the switch to decouple the antenna port of the switch from the receive port of the switch or to couple the antenna port to a selected one of the at least one termination impedance.

Clause 20. The antenna switch apparatus of clause 19, wherein the receive circuitry disable signal is a low-noise amplifier disable signal.

Clause 21. The antenna switch apparatus of clause 19, wherein the at least one termination impedance comprises a plurality of termination impedances and the at least one termination port comprises a plurality of termination ports, and wherein the switch controller is configured to select which of the plurality of termination ports to have the switch couple to the antenna port based on one or more indications received by the switch controller from a modem of a device in which the antenna switch apparatus is disposed.

Clause 22. The antenna switch apparatus of clause 21, wherein the one or more indications received by the switch controller comprise one or more indications of signal transmission.

Clause 23. The antenna switch apparatus of clause 21, wherein the one or more indications received by the switch controller comprise at least a part of one or more call setup communications.

Clause 24. A wireless communication device, comprising:
transmit circuitry configured to transmit an outbound signal for transmission by a first antenna of a plurality of antennas of the wireless communication device;
receive circuitry configured to receive an inbound signal from a second antenna of the plurality of antennas of the wireless communication device, the second antenna being distinct from the first antenna;
a processor communicatively coupled to the transmit circuitry and the receive circuitry and configured to transmit a first subset of possible transmission parameter values for the wireless communication device and a second subset of possible transmission parameter values for the wireless communication device; and
an antenna switch or an antenna switch module communicatively coupled to the transmit circuitry, the receive circuitry, and the processor, the antenna switch or antenna switch module being configured to receive the first subset of possible transmission parameter values and selectively detune, during a call, the second antenna based on the first subset of possible transmission parameter values, and to receive the second subset of possible transmission parameter values and selectively re-detune the second antenna based on the second subset of possible transmission parameters.

Clause 25. The wireless communication device of clause 24, wherein the processor is configured to transmit, on a slot-by-slot basis, one or more indications of signal transmission.

Clause 26. The wireless communication device of clause 24, wherein the transmit circuitry, the receive circuitry, and the processor are configured to perform time division duplexing (TDD) alternating between signal transmission and signal reception, and wherein the processor is configured to:
transmit, for each of a plurality of signal transmissions, one or more indications of signal transmission; and
transmit, for each of a plurality of signal receptions, one or more indications of transmission disablement.

Clause 27. The wireless communication device of clause 26, wherein for at least one of the plurality of signal transmissions, the one or more indications of signal transmission comprises one or more indications of disablement of the receive circuitry independent of the possible transmission parameter values.

Clause 28. The wireless communication device of clause 27, wherein the antenna switch or antenna switch module is configured to detune the second antenna and re-detune the second antenna based on the one or more indications of disablement of the receive circuitry.

Other Considerations

Other examples and implementations are within the scope of the disclosure and appended claims. For example, configurations other than those shown may be used. Also, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices (also called wireless communications devices). A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or +0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or +0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. An antenna connection/termination device comprising:
a first antenna port configured to communicatively couple to a first antenna;
a first switch communicatively coupled to the first antenna port;
transceiver circuitry communicatively coupled to the first switch and including transmit circuitry and first receive circuitry, wherein the first switch is configured to selectively communicatively couple the first antenna port to the transmit circuitry or the first receive circuitry;
a second antenna port configured to communicatively couple to a second antenna;
a second switch communicatively coupled to the second antenna port;
second receive circuitry communicatively coupled to the second switch;
one or more terminations, having a corresponding one or more different impedances, wherein the second switch is configured to selectively communicatively couple the second antenna port to the second receive circuitry or one of the one or more terminations;
a processor communicatively coupled to the transceiver circuitry, the second receive circuitry, the first switch, and the second switch, and configured to provide one or more indications of transceiver operation including time-division multiplexing between operation of the transmit circuitry to transmit a transmit signal and operation of the first receive circuitry, and corresponding selective communicative coupling by the first switch of the first antenna port to the transmit circuitry or to the first receive circuitry; and
a hardware switch controller communicatively coupled to the processor and the second switch and configured to control the second switch to communicatively couple the second antenna port to a selected one of the one or more terminations based on the one or more indications of transceiver operation in accordance with the time-division multiplexing between operation of the transmit circuitry and operation of the first receive circuitry.

2. The antenna connection/termination device of claim 1, wherein the hardware switch controller and the second switch are configured such that the second switch changes between communicatively coupling the second antenna port to the second switch and communicatively coupling the second antenna port to one of the one or more terminations such that the second receive circuitry communicatively couples the second antenna port to one of the one or more terminations for a time duration that is time aligned with transmission of the transmit signal.

3. The antenna connection/termination device of claim 1, wherein the hardware switch controller is configured to actuate the second switch in response to a disable signal indicating to disable an amplifier of the second receive circuitry.

4. The antenna connection/termination device of claim 1, wherein the hardware switch controller is configured to actuate the second switch in response to a disable signal indicating to disable an antenna switch module.

5. The antenna connection/termination device of claim 1, wherein the one or more terminations correspond to a plurality of terminations that correspond to a plurality of gains for the first antenna, and wherein the hardware switch controller is configured to control the second switch to communicatively couple the second antenna port to the selected one of the plurality of terminations with a highest one of the plurality of gains for the first antenna.

6. The antenna connection/termination device of claim 1, wherein the one or more terminations include a short circuit, an open circuit, and an intermediate termination having an impedance between a short circuit impedance and an open circuit impedance.

7. An antenna detuning method comprising:
time domain duplexing signal transmission and signal reception by a first antenna of a wireless communication device;
providing one or more first indications of time domain duplexing and one or more second indications of signal transmission to a semi-autonomous hardware controller of the wireless communication device; and
responding, at the semi-autonomous hardware controller of the wireless communication device, to the one or more first indications of time domain duplexing and the one or more second indications of signal transmission by coupling a second antenna of the wireless communication device to receive circuitry during signal reception by the first antenna and to a termination during signal transmission by the first antenna.

8. The antenna detuning method of claim 7, wherein the coupling of the second antenna to the receive circuitry and to the termination is time aligned with the time domain duplexing signal transmission and signal reception by the first antenna.

9. The antenna detuning method of claim 7, wherein the coupling of the second antenna to the termination is in response to a disable signal indicating to disable the receive circuitry.

10. The antenna detuning method of claim 7, wherein the coupling of the second antenna to the termination is in response to a disable signal indicating to disable an antenna switch module of the wireless communication device.

11. The antenna detuning method of claim 7, wherein the coupling of the second antenna to the termination comprises coupling the second antenna to one of a plurality of terminations based on the one or more second indications of the signal transmission, wherein the plurality of terminations correspond to a plurality of gains for the first antenna, and wherein the coupling of the second antenna to one of the plurality of terminations couples the second antenna to a selected one of the plurality of terminations with a highest one of the plurality of gains for the first antenna.

12. The antenna detuning method of claim 11, wherein the plurality of terminations include a short circuit, an open circuit, and an intermediate termination having an impedance between a short circuit impedance and an open circuit impedance.

13. An antenna switch apparatus comprising:
a switch controller;
at least one termination impedance; and
a switch communicatively coupled to the switch controller, the switch comprising an antenna port configured to be communicatively coupled to an antenna, a receive port configured to be communicatively coupled to receive circuitry, and at least one termination port each communicatively coupled to a respective one of the at least one termination impedance;
wherein the switch controller is configured to respond to reception of a receive circuitry disable signal by causing the switch to decouple the antenna port of the switch from the receive port of the switch or to couple the antenna port to a selected one of the at least one termination impedance.

14. The antenna switch apparatus of claim 13, wherein the receive circuitry disable signal is a low-noise amplifier disable signal.

15. The antenna switch apparatus of claim 13, wherein the at least one termination impedance comprises a plurality of termination impedances and the at least one termination port comprises a plurality of termination ports, and wherein the switch controller is configured to select which of the plurality of termination ports to have the switch couple to the antenna port based on one or more indications received by the switch controller from a modem of a device in which the antenna switch apparatus is disposed.

16. The antenna switch apparatus of claim 15, wherein the one or more indications received by the switch controller comprise one or more indications of signal transmission.

17. The antenna switch apparatus of claim 15, wherein the one or more indications received by the switch controller comprise at least a part of one or more call setup communications.

18. A wireless communication device comprising:
transmit circuitry configured to transmit an outbound signal for transmission by a first antenna of a plurality of antennas of the wireless communication device;
receive circuitry configured to receive an inbound signal from a second antenna of the plurality of antennas of the wireless communication device, the second antenna being distinct from the first antenna;
a processor communicatively coupled to the transmit circuitry and the receive circuitry and configured to transmit a first subset of possible transmission parameter values for the wireless communication device and a second subset of possible transmission parameter values for the wireless communication device; and
an antenna switch or an antenna switch module communicatively coupled to the transmit circuitry, the receive circuitry, and the processor, the antenna switch or antenna switch module being configured to receive the first subset of possible transmission parameter values and selectively detune, during a call, the second antenna based on the first subset of possible transmission parameter values, and to receive the second subset of possible transmission parameter values and selectively re-detune the second antenna based on the second subset of possible transmission parameters.

19. The wireless communication device of claim 18, wherein the processor is configured to transmit, on a slot-by-slot basis, one or more indications of signal transmission.

20. The wireless communication device of claim 18, wherein the transmit circuitry, the receive circuitry, and the processor are configured to perform time division duplexing (TDD) alternating between signal transmission and signal reception, and wherein the processor is configured to:
transmit, for each of a plurality of signal transmissions, one or more indications of signal transmission; and
transmit, for each of a plurality of signal receptions, one or more indications of transmission disablement.

21. The wireless communication device of claim 20, wherein for at least one of the plurality of signal transmissions, the one or more indications of signal transmission comprises one or more indications of disablement of the receive circuitry independent of the possible transmission parameter values.

22. The wireless communication device of claim 21, wherein the antenna switch or antenna switch module is configured to detune the second antenna and re-detune the second antenna based on the one or more indications of disablement of the receive circuitry.
